(19) United States
(12) Patent Application Publication
(10) Pub. No.: US 2006/0127596 A1
(43) Pub. Date: Jun. 15, 2006

(54) Method and apparatus for manufacturing a polarizer

(75) Inventor: Ga-Lane Chen, Fullerton, CA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 11/298,351

(22) Filed: Dec. 9, 2005

(30) Foreign Application Priority Data
Dec. 10, 2004 (TW) 93138296

(51) Int. Cl. B05D 5/06; B05C 11/02

(52) U.S. Cl. 427/554; 427/163.1; 349/194; 118/110

(57) ABSTRACT

A method for manufacturing a polarizer includes: providing a substrate; coating the substrate with a polarizing layer; orienting most of the molecules of the polarizing layer by using a plurality of roller devices; and using a laser device to orient the remaining molecules. The method can increase the shape anisotropy of the polarizer. When the polarizer is used in an LCD (liquid crystal display) device, light provided for a display of the LCD device is increased, and the light utilization rate of the LCD device is improved. The polarizer manufacturing apparatus can further include a transducer between each roller and the substrate having the polarizing layer.

### BACKGROUND

1. Field of the Invention

The present invention relates to a method and an apparatus for manufacturing an optical polarizer.

2. General Background

Liquid crystal display (LCD) devices are in widespread use in personal computers, desk-top calculators, electronic clocks, word-processors, automobiles, and other machines. Nearly all LCD devices include one or more polarizers, which function as filters with regard to the polarization of light.

A typical method for manufacturing a liquid crystal material polarizer is set out in FIG. 3. The method includes the following steps: providing a containment medium for containing the liquid crystal material; casting an emulsion of liquid crystal material with pleochroic dye in the containment medium; and stretching such cast material to form elongate volumes of liquid crystal and pleochroic dye in such containment medium using a plurality of roller devices.

However, a performance of a liquid crystal material polarizer manufactured by the typical method can not be satisfactorily used in an LCD device, because a shape anisotropy of the polarizer is not optimized throughout.

What is needed, therefore, is a method and an apparatus for manufacturing an optical polarizer with optimized shape anisotropy.

### SUMMARY

In one preferred embodiment, a method for manufacturing a polarizer for an LCD device includes the following steps: providing a substrate; coating the substrate with a polarizing layer; orienting most of the molecules of the polarizing layer by using a plurality of roller devices; and then using a laser device to orient the remaining molecules. The method improves the shape anisotropy of the polarizer. When the polarizer is used in an LCD device, light provided for a display of the LCD device is increased, and the light utilization rate of the LCD device is optimized.

In another preferred embodiment, an apparatus for manufacturing a polarizer includes a plurality of roller devices arranged on two sides of a path for passage of a polarizer preform, and a laser device arranged next in processing sequence after the roller devices. The polarizer manufacturing apparatus can further include a plurality of transducers, each transducer being located between a respective roller and a polarizer layer of the polarizer preform.

Other advantages and novel features will become more apparent from the following detailed description of preferred embodiments when taken in conjunction with the accompanying drawings, in which:

### BRIEF DESCRIPTION OF THE DRAWINGS

FIG. 1 is a flow chart of a method for manufacturing a polarizer in accordance with one preferred embodiment of the present invention;

FIG. 2 is a schematic, side view of an apparatus for manufacturing a polarizer in accordance with another preferred embodiment of the present invention, together with a polarizer preform; and

FIG. 3 is a flow chart of a conventional method for manufacturing a polarizer.

### DETAILED DESCRIPTION OF THE EMBODIMENTS

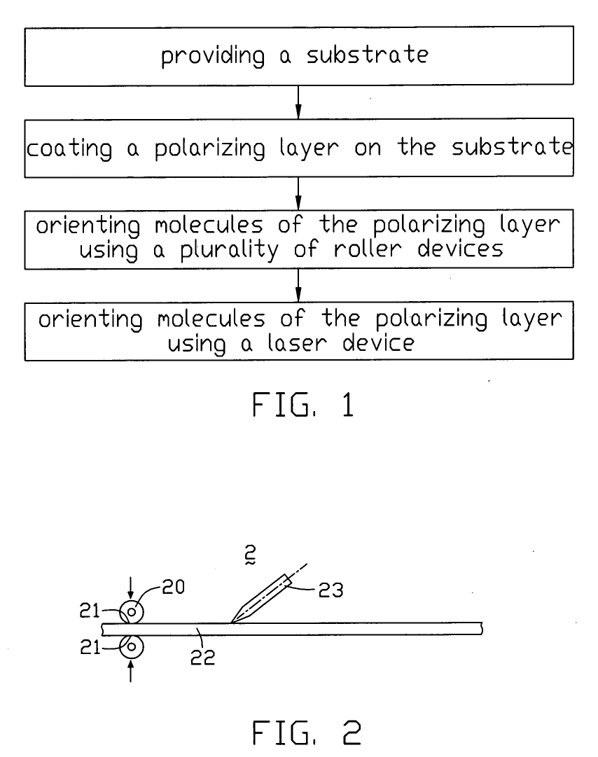

FIG. 1 shows a method for manufacturing a polarizer according to a preferred embodiment of the present invention. The method includes the following steps.

First, providing a substrate. The substrate can be made from transparent glass or plastic.

Second, coating the substrate with a polarizing layer. The polarizing layer is coated on one main side of the substrate, and can be made from polyvinyl alcohol (PVA) embedded with a polarizing material. The polarizing material can be an iodine type polarizing material, a dye type polarizing material, a polyvinyl polarizing material such as fluorinated polyimide, or a metallic polarizing material such as Ag—As—S material. The polarizing layer is for transforming natural light into linear polarized light.

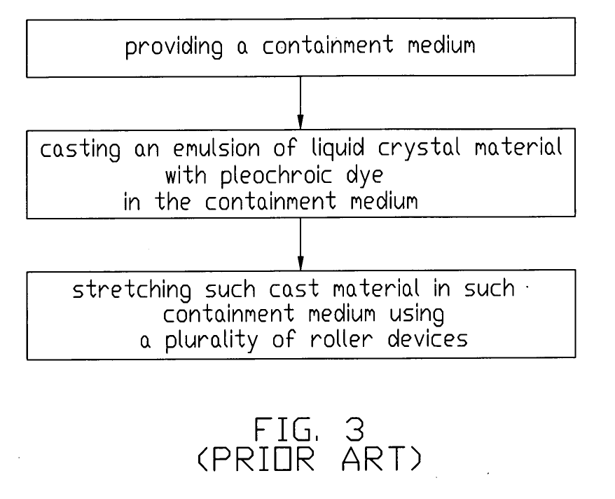

Third, orienting the molecules of the polarizing layer using a plurality of roller devices. The roller devices apply contact force on the polarizing layer, whereby a significant number of the molecules of the polarizing layer are oriented into a preferred orientation to improve shape anisotropy of the polarizing layer. The roller devices can comprise common rollers, and/or rollers with electrodes. When rollers with electrodes are used adjacent the polarizing layer, the molecules of the polarizer are oriented by the electric field between the electrodes of the rollers. In addition, the contact force applied to the polarizing layer by the roller devices can be measured by a sensor arranged in each roller. The contact force can be adjusted by a transducer arranged between each roller and the substrate having the polarizing layer. The sensor and the transducer are described in more detail below in relation to FIG. 2.

Finally, orienting the remaining molecules of the polarizing layer using a laser device. The laser device irradiates the polarizing layer with laser beams. The laser beams can be polarized laser beams. Because laser beams have the properties of high energy density and a regular phase, the laser beams do not diffuse during propagation. Thus, the remaining molecules of the polarizing layer can be oriented.

After most molecules of the polarizing layer are oriented by the roller devices, the remaining molecules are oriented by laser beams from the laser device for further creating shape anisotropy. Thus, the shape anisotropy and the polarization of the polarizer are improved. When the polarizer is used in an LCD device, light provided for a display of the LCD device is increased, and the light utilization rate of the LCD device is improved.

FIG. 2 shows an apparatus for manufacturing a polarizer according to another preferred embodiment of the present invention. The apparatus 2 includes a plurality of roller devices 20 arranged on two sides of a path for passage of a polarizer preform 22, and a laser device 23 arranged next in processing sequence after the roller devices 20. The polarizer preform 22 includes a substrate (not shown) and a polarizing layer (not shown) coated on a top of the substrate. Each roller device 20 includes a piezoelectric sensor 21 disposed therein, for detecting and controlling contact force applied to the polarizer preform 22 by the roller device 20. An angle between the laser device 23 and the normal of the polarizer preform 22 is in the range from 30° to 75°. The roller devices 20 can cooperatively apply contact force to the polarizer preform 22 passing therebetween, in order to create a desired shaped anisotropy of the polarizer preform 22 and orient the molecules of the polarizer layer. Thereafter, the laser device 23 irradiates the polarizing layer, thereby orienting the remaining molecules.

It is of advantage that the shape anisotropy of the polarizer preform 22 is further improved by the laser beams from the laser device 23. When a polarizer manufactured by the apparatus 2 is used in an LCD device, light provided for a display of the LCD device is increased, and the light utilization rate of the LCD device is improved.

In alternative embodiments, the method for manufacturing the polarizer can further include coating an anti-reflection layer and/or an anti-glare layer on a surface of the polarizer.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a polarizer, comprising the following steps:
providing a substrate, and coating the substrate with a polarizing layer;
orienting molecules of the polarizing layer using a plurality of roller devices; and
orienting molecules of the polarizing layer using a laser device.

2. The method as claimed in claim 1, wherein the polarizing layer comprises polyvinyl alcohol embedded with polarizing material.

3. The method as claimed in claim 2, wherein the polarizing material comprises iodine type polarizing material.

4. The method as claimed in claim 2, wherein the polarizing material comprises dye type polarizing material.

5. The method as claimed in claim 2, wherein the polarizing material comprises polyvinyl polarizing material.

6. The method as claimed in claim 5, wherein the polyvinyl polarizing material comprises fluorinated polyimide.

7. The method as claimed in claim 2, wherein the polarizing material comprises metallic polarizing material.

8. The method as claimed in claim 7, wherein the metallic polarizing material comprises Ag—As—S material.

9. The method as claimed in claim 1, further comprising coating an anti-reflection layer on a surface of the polarizer.

10. The method as claimed in claim 1, further comprising coating an anti-glare layer on a surface of the polarizer.

11. The method as claimed in claim 1, wherein light emitted from the laser device is polarized.

12. An apparatus for manufacturing a polarizer, comprising:
a plurality of roller devices arranged on two sides of a path for passage of a polarizer preform; and
a laser device arranged next in processing sequence after the roller devices.

13. The apparatus as claimed in claim 12, wherein each roller device comprises a piezoelectric sensor.

14. The apparatus as claimed in claim 12, further comprising at least one transducer associated with the roller devices.

15. The apparatus as claimed in claim 12, wherein an angle between the laser device and the normal of the polarizer preform is in the range from 30° to 75°.

16. A method for manufacturing a polarizer, comprising the steps of:
preparing a substrate as a main portion of a polarizer;
coating a polarizing layer onto said substrate;
normally pressing said polarizing layer toward said substrate for orienting molecules of said polarizing layer; and
laser-treating said polarizing layer for further orienting molecules of said polarizing layer.

17. The method as claimed in claim 16, wherein at least two rollers are respectively movably arranged at two sides of a passing path for said substrate so as to be moved against said passing substrate in order for providing said normally pressing onto said polarizing layer.
